(19) United States
(12) Patent Application Publication
(10) Pub. No.: US 2026/0184179 A1
(43) Pub. Date: Jul. 2, 2026

(54) CONTROL SYSTEM FOR VEHICLE

(71) Applicant: TOYOTA JIDOSHA KABUSHIKI KAISHA, Toyota-shi (JP)

(72) Inventor: Naoya ODASHIMA, Toyota-shi (JP)

(73) Assignee: TOYOTA JIDOSHA KABUSHIKI KAISHA, Toyota-shi (JP)

(21) Appl. No.: 19/415,980

(22) Filed: Dec. 11, 2025

(30) Foreign Application Priority Data
Dec. 27, 2024 (JP) 2024-231828

(51) Int. Cl. B60L 3/00; B60L 15/00; B60L 15/20

(52) U.S. Cl. CPC B60L 3/0046; B60L 3/0007; B60L 15/007; B60L 15/20

(57) ABSTRACT

A control system for a vehicle a control system for a vehicle configured to discharge residual charge on a capacitor utilizing an existing power source in the event of a collision of the vehicle. The control system comprises: a high-voltage power source; a motor; a power conversion equipment; a capacitor storing an electrical charge; an auxiliary power source; a motor controller; and a main controller. The control system is configured to control a main relay to disconnect the high-voltage power source from the capacitor and to connect the capacitor with a resistor arranged in parallel with the motor, in the event of a collision of the vehicle.

### CROSS-REFERENCE TO RELATED APPLICATIONS

The present disclosure claims the benefit of Japanese Patent Application No. 2024-231828 filed on December 27, 2024 with the Japanese Patent Office, the disclosures of which are incorporated herein by reference in its entirety.

### BACKGROUND

### Field of the Disclosure

The embodiment of the present disclosure relates to the art of a control system for a vehicle having a motor serving as a prime mover.

### Discussion of the Related Art

JP-A-2011-259517 and JP-A-2017-070045 disclose examples of a control system for a vehicle having a motor serving as a prime mover, a high-voltage power supply for the motor, and a power conversion equipment that controls electric power supplied from the high-voltage power supply to the motor. The control systems taught by the above-mentioned prior art documents are individually configured to discharge residual charge on a capacitor arranged in the power conversion device in the event of a collision of the vehicle.

The control system described in JP-A-2011-259517 is configured to supply electric power to an ECU for controlling the power conversion equipment from an auxiliary power source provided outside the power conversion equipment, and to discharge residual charge from the capacitor even when a power line connecting the auxiliary power source and the ECU is broken due to collision of the vehicle. According to the teachings of JP-A-2011-259517, specifically, a backup power source for supplying electric power to the ECU using the power of the power conversion equipment is arranged in a housing in which the power conversion equipment is arranged, and the backup power source is operated to supply electric power to the ECU when the electric power cannot be supplied from the auxiliary power supply to the ECU. The ECU described therein is configured to transmit a gate signal to a switching element arranged in a converter serving as the power conversion equipment or a switching element arranged on an output side of the converter. According to the teachings of JP-A-2011-259517, therefore, current flows through a reactor arranged in the converter and a resistance element connected in series with the switching element so that the residual charge on the capacitor is discharged.

The power supply system described in JP-A-2017-070045 is configured to determine whether a voltage of a capacitor is equal to or higher than a reference voltage when a power supply voltage for the ECU temporarily decreases and a resetting operation the ECU is executed, and to transmit a gate signal to a switching element arranged in the converter when the voltage of the capacitor is equal to or higher than the reference voltage. According to the teachings of JP-A-2017-070045, therefore, a residual charge on the capacitor is discharged by a current flowing through a reactor arranged in the converter.

As described, according to the teachings of JP-A-2011-259517, the electric current flows through the reactor as a discharging device by transmitting the gate signal to the switching element arranged in the power conversion equipment so that the residual charge on the capacitor is discharged. To this end, the electric power is supplied to the ECU transmitting the gate signal from the backup power source arranged in the housing together with the power conversion equipment. That is, the control system described in JP-A-2011-259517 is provided with a dedicated power source for discharging the residual charges of the capacitor, and hence a size of the power conversion equipment may be increased by the backup power source.

### SUMMARY

The embodiment of the present disclosure has been conceived noting the foregoing technical problems, and it is therefore an object of the present disclosure to provide a control system for a vehicle configured to discharge a residual charge on a capacitor utilizing an existing power source in the event of a collision of the vehicle.

According to the exemplary embodiment the present disclosure, there is provided a control system for a vehicle, comprising: a high-voltage power source; a motor that is driven by electric power supplied from the high-voltage power source; a power conversion equipment that converts the electric power supplied from the high-voltage power source and that outputs the converted electric power to the motor; a capacitor that stores an electrical charge arranged between the high-voltage power source and the motor; an auxiliary power source whose voltage is lower than that of the high-voltage power source; a motor controller that controls the electric power supplied to the motor by supplying the electric power from the auxiliary power source to the power conversion equipment; and a main controller to which the electric power is supplied from the auxiliary power source, and that transmits a command signal to the motor controller in accordance with the electric power supplied to the motor. The control system comprising: a main relay that selectively interrupts a transmission of the electric power between the high-voltage power source and the capacitor; a collision determiner that determines a collision of the vehicle; a resistor having a resistance value equal to or greater than a predetermined value that is arranged in parallel with the motor; and a discharging relay that selectively connects the capacitor with the resistor. In order to achieve the above-explained objective, according to the exemplary embodiment of the present disclosure, the main controller comprises: an interrupter that controls the main relay to disconnect the high-voltage power source from the capacitor when the collision determiner determines a collision of the vehicle; and a discharge controller that controls the discharging relay to connect the capacitor with the resistor when the collision determiner determines a collision of the vehicle.

In a non-limiting embodiment, the resistor may include a heater that heats water flowing in the vehicle.

In a non-limiting embodiment, the control system may further comprise: a first power line connecting the auxiliary power source with the motor controller; and a second power line connecting the auxiliary power source with the main controller. In addition, the second power line may be more difficult to be broken than the first power line in the event of a collision of the vehicle.

In a non-limiting embodiment, the power conversion equipment may include a converter having: a switching element that allows current to flow from the motor to the high-voltage power source by supplying the electric power from the auxiliary power source to a gate, and a diode that is arranged in parallel with the switching element such that the current is allowed to flow only from the high-voltage power source to the motor.

Thus, in the control system according to the exemplary embodiment of the present disclosure, the resistor is arranged in parallel with the motor, and the resistor and the capacitor are selectively connected with each other through the discharging relay. According to the exemplary embodiment of the present disclosure, therefore, a current flows through the resistor by rendering the discharge relay conductive so that a residual charge on the capacitor is discharged. Specifically, the discharging relay is activated by the electric power supplied from the main controller, and the motor controller controls the motor by supplying the electric power from the auxiliary power source to the power conversion equipment. In the event of a collision of the vehicle, the power line connecting the auxiliary power source and the motor controller and the power line for transmitting the gate signal from the motor controller to the power conversion equipment may be broken, and consequently the power conversion equipment may become out of control. However, according to the exemplary embodiment of the present disclosure, the residual charge on the capacitor may be discharged even in this situation by supplying the electric power from the main controller to the discharging relay. That is, the residual charge may be discharged from the capacitor utilizing the existing main controller without increasing the size of the system.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is an electrical diagram schematically showing one example of an electric circuit according to the exemplary embodiment of present disclosure including a high-voltage power source, a motor, a capacitor, and a power conversion equipment;

FIG. 2 is a block diagram showing electric power supplied to the main-ECU and the MG-ECU, and signals transmitted to/from the main-ECU and the MG-ECU;

FIG. 3 is a block diagram showing functions of the controller: and

FIG. 4 is a flowchart showing one example of a routine for discharging residual charge from a smoothing capacitor in the event of a collision of the vehicle.

### DETAILED DESCRIPTION OF THE PREFERRED EMBODIMENT(S)

An embodiment of the present disclosure will now be explained with reference to the accompanying drawings. Note that the embodiments shown below are merely examples of the present disclosure, and do not limit the present disclosure.

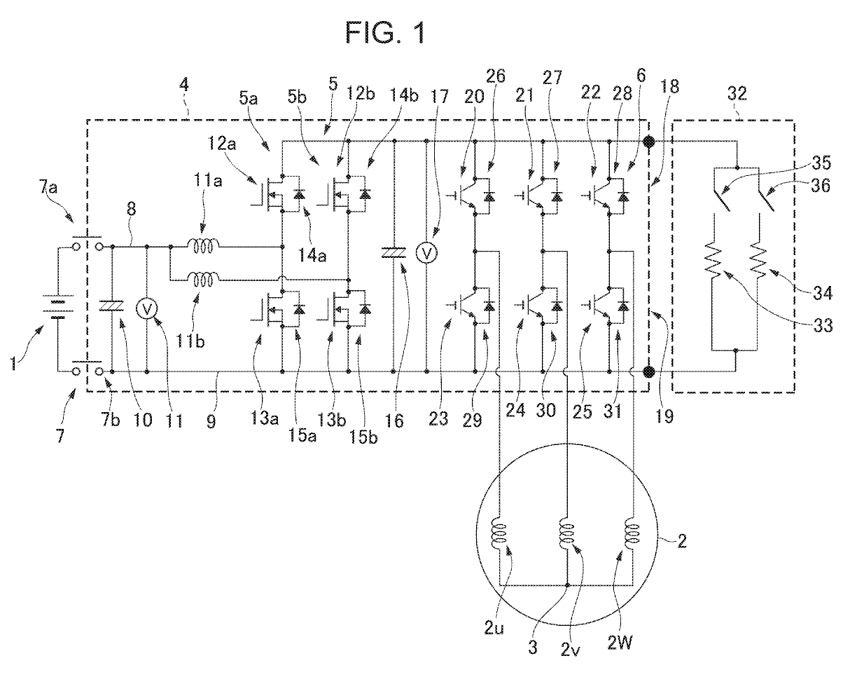

Referring now to FIG. 1, there is shown one example of an electric circuit according to the exemplary embodiment of the present disclosure comprising a high-voltage power source, a motor, a capacitor, and a power conversion equipment. As power sources of conventional electric vehicles and hybrid vehicles, the high-voltage power source 1 is adapted to output a DC voltage. For example, a secondary battery such as a lithium-ion battery and a nickel-hydrogen battery, and an electric double layer capacitor may be adopted as the high-voltage power source 1. In the electric circuit shown in FIG. 1, an assembled battery in which a plurality of batteries are arranged in series is adopted as the high-voltage power source 1.

As motors serving as prime movers in the conventional electric vehicles and hybrid vehicles, a three-phase AC synchronous motor having a plurality of permanent magnets in a rotor may be adopted as the motor 2. That is, the motor 2 is activated by supplying an AC voltage. In the embodiment shown in FIG. 1, an AC motor having a star connection arrangement is adopted as the motor 2, and the motor 2 comprises a U-phase coil 2u, a V-phase coil 2v, and a W-phase coil 2w. One end of each of the coils 2u, 2v, and 2w is individually connected with a neutral point 3.

As illustrated in FIG. 1, a power control unit (hereinafter referred to as PCU) 4 is arranged between the high-voltage power source 1 and the motor 2. The PCU 4 comprises a converter 5 that boosts or lowers the voltage of electricity transmitted between the high-voltage power source 1 and the motor 2, and an inverter 6 that converts DC voltage supplied from the high-voltage power source 1 into AC voltage and outputs the converted AC voltage to the motor 2, and that converts AC voltage generated by the motor 2 into DC voltage to charge the high-voltage power source 1 with the converted DC voltage.

The high-voltage power source 1 is electrically disconnected from the PCU 4 by a system main relay (hereinafter referred to as SMR) 7. As SMRs arranged in the conventional electric circuits, the SMR 7 comprises a positive side system main relay (hereinafter referred to as SMR-B) 7a and a negative side system main relay (hereinafter referred to as SMR-G) 7b.

Specifically, a positive bus line 8 is connected with a positive electrode of the high-voltage power source 1, and the SMR-B 7a is provided on the positive bus line 8 to selectively disconnect the positive electrode of the high-voltage power source 1 from the PCU 4. Likewise, a negative bus line 9 is connected with a negative electrode of the high-voltage power source 1, and the SMR-G 7b is provided on the negative bus line 9 to selectively disconnect the negative electrode of the high-voltage power source 1 from the PCU 4. In order not to flow a high current abruptly when the SMR 7 is turned on, an optional bypass circuit including a resistor (not shown) and a system main relay for precharging arranged in series with the resistor may be arranged in parallel to the SMR-G 7b.

A first smoothing capacitor 10 is connected with an output side of the SMR7 to suppress fluctuations of the output voltage from the high-voltage power source 1 and the input voltage to the high-voltage power source 1. Specifically, a positive terminal of the first smoothing capacitor 10 is connected with the positive bus line 8, and a negative terminal of the first smoothing capacitor 10 is connected with the negative bus line 9. In order to detect a voltage of charge on the first smoothing capacitor 10, a first voltmeter 11 is arranged in parallel with the first smoothing capacitor 10.

In the example shown in FIG. 1, a pair of the converter 5a and a converter 5b are connected in parallel with each other, and structures of the converters 5a and 5b are similar to each other. Therefore, in the following description, only the converter 5a will be explained, and the explanations for the other converter 5b will be omitted. In connection therewith, in FIG. 1, components of the converter 5a are denoted by reference numerals "a", and components of the converter 5b are denoted by reference numerals "b".

The converter 5a comprises a reactor 11a, a pair of metal-oxide-semiconductor field-effect transistors (i.e., MOSFETs) 12a and 13a, and a pair of diodes 14a and 15a. In the following explanation, the MOSFETs 12a and 13a will be simply referred to as the switching elements 12a and 13a. One end of the reactor 11a is connected in series with the positive bus line 8 in an output side of the first smoothing capacitor 10, and the other end the reactor 11a is connected with the positive bus line 8 between a source of the switching element 12a and a drain of the switching element 13a.

The switching elements 12a and 13a are connected with each other in series between the positive bus line 8 and the negative bus line 9. Specifically, a drain of the switching element 12a is connected with the positive bus line 8, and a source of the switching element 13a is connected with the negative bus line 9. The diode 14a is arranged in parallel with the switching element 12a so that the current is allowed to flow only from the source to the drain of the switching element 12a. Likewise, the diode 15a is arranged in parallel with the switching element 13a so that the current is allowed to flow only from the source to the drain of the switching element 13a. That is, a current is allowed to flow from the high-voltage power source 1 to the motor 2 without controlling the switching elements 12a and 13a. Instead, an insulated gate bipolar transistor or the like may also be adopted as the switching elements 12a and 13a.

In order to suppress a fluctuation of an output voltage from the converter 5, a second smoothing capacitor 16 is connected with the positive bus line 8 and the negative bus line 9 in the output side of the converter 5. In addition, in order to detect a voltage of charge on the second smoothing capacitor 16, a second voltmeter 17 is arranged in parallel with the second smoothing capacitor 16.

The inverter 6 is also connected with the positive bus line 8 and the negative bus line 9. That is, the inverter 6 is arranged in parallel with the second smoothing capacitor 16. The inverter 6 comprises an upper arm switch 18 and a lower arm switch 19, each of which is an insulated gate bipolar transistor (IGBT). Specifically, a collector as a high potential side terminal of the upper arm switch 18 is connected with the positive bus line 8, an emitter as a low potential side terminal of the upper arm switch 18 is connected with a collector as a high potential side terminal of the lower arm switch 19, and an emitter as a low potential side terminal of the lower arm switch 19 is connected with the negative bus line 9. Thus, the upper arm switch 18 and the lower arm switch 19 are connected in series with each other.

As described above, since the motor 2 shown in FIG. 1 is a three-phase AC motor, each of the upper arm switch 18 and the lower arm switch 19 comprises three switches. Specifically, the upper arm switch 18 comprises a first switching element 20 connected with the U-phase coil 2u, a third switching element 21 connected with the V-phase coil 2v, and a fifth switching element 22 connected to the W-phase coil 2w. On the other hand, the lower arm switch 19 comprises a second switching element 23 connected with the U-phase coil 2u, a fourth switching element 24 connected with the V-phase coil 2v, and a sixth switching element 25 connected with the W-phase coil 2w. In addition, diodes 26, 27, 28, 29, 30, and 31 are connected in antiparallel with the switching elements 20, 21, 22, 23, 24, and 25, respectively. Here, it is to be noted that a switching element such as the MOSFET may also be adopted as each of the switching elements 20, 21, 22, 23, 24, and 25.

One end of the U-phase coil 2u is connected with a connection point between the first switching element 20 and the second switching element 23, one end of the V-phase coil 2v is connected with a connection point between the third switching element 21 and the fourth switching element 24, and one end of the W-phase coil 2w is connected with a connection point between the fifth switching element 22 and the sixth switching element 25. As described above, the other ends of the U-phase coil 2u, the V-phase coil 2v, and the W-phase coil 2w are connected with the neutral point 3.

In addition, a heater 32 is arranged in parallel with the second smoothing capacitor 16 and the inverter 6. The heater 32 is adapted to heat water flowing through an air conditioner or a sheet, and the heated water serves as a heat source for the air conditioner or the sheet. Specifically, the heater 32 comprises a pair of resistors 33 and 34 arranged in parallel with each other, a heater relay 35 that is rendered conductive and non-conductive to selectively connect and disconnect the resistor 33 with/from the positive bus line 8, and a heater relay 36 that is rendered conductive and non-conductive to selectively connect and disconnect the resistor 34 with/from the positive bus line 8. These heater relays 35 and 36 serve as the discharging relays of the exemplary embodiment of the present disclosure.

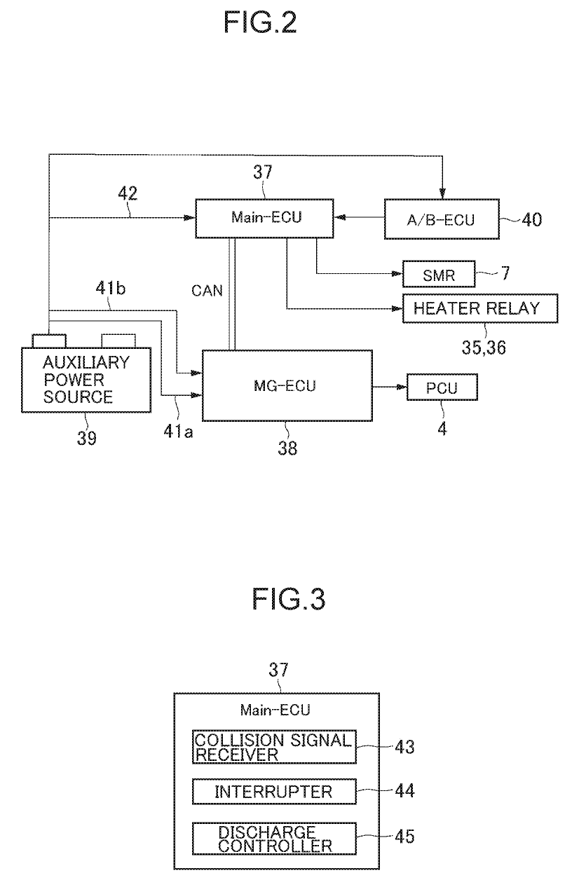

The switching elements 20, 21, 22, 23, 24, and 25 and the relays 7a, 7b, 35, and 36 are activated upon reception of command signals from a Main-ECU 37 as a main controller and a MG-ECU 38 as a motor controller. Turning to FIG. 2, there are shown the electric power supplied to the Main-ECU 37 and the MG-ECU 38 and the signals transmitted to/from the Main-ECU 37 and the MG-ECU 38.

As shown in FIG. 2 the control system is provided with an auxiliary power source 39 whose voltage is lower than that of the high-voltage power source 1. As conventional power sources of auxiliary devices such as lights and electric devices arranged in vehicles, for example, a secondary battery such as a zinc battery may be adopted as the auxiliary power source 39.

The Main-ECU 37, the MG-ECU 38 and an A/B-ECU 40 are electrically connected with the auxiliary power source 39. Specifically, the auxiliary power source 39 is connected with the MG-ECU 38 through a pair of power lines 41a and 41b each of which serves as the first power line of the exemplary embodiment of the present disclosure.

Each of the Main-ECU 37, the MG-ECU 38 and the A/B-ECU 40 is an electronic control unit comprising a microcomputer. The Main-ECU 37, the MG-ECU 38 and the A/B-ECU 40 are individually configured to perform a calculation based on signals transmitted from various sensors (not shown) arranged in the vehicle and other ECU(s), using formulas stored in advance and with reference to maps also stored in advance. Calculation results are transmitted to other ECU(s) and electric components in the form of command signals.

Specifically, the Main-ECU 37 is configured to calculate a drive force required to propel the vehicle based on the signals transmitted from e.g., a sensor detecting an operation amount of an accelerator device (not shown) and a sensor detecting a speed of the vehicle, and to transmit a calculation result to the MG-ECU 38 in the form of a command signal. To this end, as shown in FIG. 2, the Main-ECU 37 and the MG-ECU 38 are communicated with each other through a Controller Area Network (referred to as CAN in FIG. 2).

The Main-ECU 37 is further configured to control the SMR 7 and the heater relays 35 and 36. Specifically, when the main switch of the vehicle is turned on, the Main-ECU 37 transmits a command signal (i.e., an electric power) to an actuator (not shown) to render the SMR 7 conductive. In addition, when the temperature of the water serving as a heat source of the air conditioner and the sheet drops to a predetermined level or lower, the Main-ECU 37 transmits a command signal (i.e., an electric power) to an actuator (not shown) to render the heater relays 35 and 36 conductive. Since the heater 32 is provided with two heater relays 35 and 36, the heater relays 35 and 36 may be rendered conductive and non-conductive alternately. For example, it is possible to render the heater relay 35 conductive while rendering the heater relay 36 non-conductive, and then render the heater relay 35 non-conductive while rendering the heater relay 36 conductive.

In addition, the Main-ECU 37 is further configured to render the conductive SMR 7 non-conductive and render the non-conductive heater relays 35 and 36 conductive, when a signal to activate an airbag assembly is transmitted from the after-mentioned A/B-ECU 40.

As described above, the Main-ECU 37 calculates the required drive force to propel the vehicle, and sends the calculation result to the MG-ECU 38. Therefore, it is important to operate the Main-ECU 37 continuously. For this reason, a power line 42 as a second power line connecting the Main-ECU 37 with the auxiliary power source 39 is wired in such a manner not to be broken easier than the power lines 41a and 41b connecting the MG-ECU 38 with the auxiliary power source 39, in the event of a collision of the vehicle. Alternatively, a power line having a stiffness higher than those of the power lines 41a and 41b may be employed as the power line 42. For example, in order to protect the power line 42, the power line 42 may be wired along a relatively rigid side member, pillar, or the like. Otherwise, the cross-sectional area of the power line 42 may be increased to increase the rigidity thereof, or the power line 42 may be covered with a rigid cover member. Instead, in order to prevent the power line 42 from being subjected to a tensile load, a length of the power line 42 may be increased longer than a distance between the auxiliary power source 39 and the Main-ECU 37.

The A/B-ECU 40 serves as a collision determiner that determines a collision of the vehicle with some kind of object. To this end, a signal is transmitted from an acceleration sensor (not shown) arranged in the vehicle to the A/B-ECU 40, and the A/B-ECU 40 determines an occurrence of a collision when the detected acceleration is equal to or greater than a predetermined value, or when a change rate of the detected acceleration is equal to or higher than a predetermined rate. A determination result is transmitted from the A/B-ECU 40 to e.g., the airbag assembly or the Main-ECU 37 in the form of a command signal. That is, a command signal for activating the airbag assembly is transmitted from the A/B-ECU 40 to the Main-ECU 37.

Functions of the Main-ECU 37 are shown in FIG. 3 in detail. As shown in FIG. 3, the Main-ECU 37 comprises a collision signal receiver 43, an interrupter 44, and a discharge controller 45. The collision signal receiver 43 is configured to receive the command signal for activating the airbag assembly or the signal representing an occurrence of a collision of the vehicle transmitted from the A/B-ECU 40.

The interrupter 44 is configured to transmits a signal for rendering the SMR 7 non-conductive when the collision signal receiver 43 receives the signal representing an occurrence of a collision of the vehicle. Specifically, given that a normally-open relay is adopted as the SMR 7, the SMR 7 is rendered conductive by supplying electric power thereto, and rendered non-conductive by stopping a power supply thereto. In this case, therefore, the power supply to the MR 7 is stopped when the collision signal receiver 43 receives the signal representing an occurrence of a collision of the vehicle. Consequently, the high-voltage power source 1 is electrically disconnected from the smoothing capacitors 10 and 16, the PCU 4, and the motor 2.

The discharge controller 45 is configured to transmit signals for rendering the heater relays 35 and 36 conductive when the collision signal receiver 43 receives the signal representing an occurrence of a collision of the vehicle. Specifically, given that the normally-open relay is adopted as the heater relays 35 and 36, the heater relays 35 and 36 are rendered conductive by supplying electric power thereto, and rendered non-conductive by stopping power supply thereto. In this case, therefore, electric power is supplied to each of the heater relays 35 and 36 when the collision signal receiver 43 receives the signal representing an occurrence of a collision of the vehicle. As a result, the smoothing capacitors 10 and 16 are electrically connected with the resistors 33 and 34 of the heater 32. In this situation, electric current flows through the resistors 33 and 34 in accordance with resistance values of the resistors 33 and 34 and voltages of the smoothing capacitors 10 and 16 so that a Joule heat is generated in accordance with the current and the resistance value. As a result, the residual charges on the smoothing capacitors 10 and 16 are discharged. As described above, the diode 14a that allows the current to flow only from the source to the drain is arranged in parallel with the switching element 12a arranged on the positive bus line 8. Therefore, the first smoothing capacitor 10 is electrically connected with the resistors 33 and 34 without controlling the switching elements of the PCU 4 by rendering the heater relays 35 and 36 conductive.

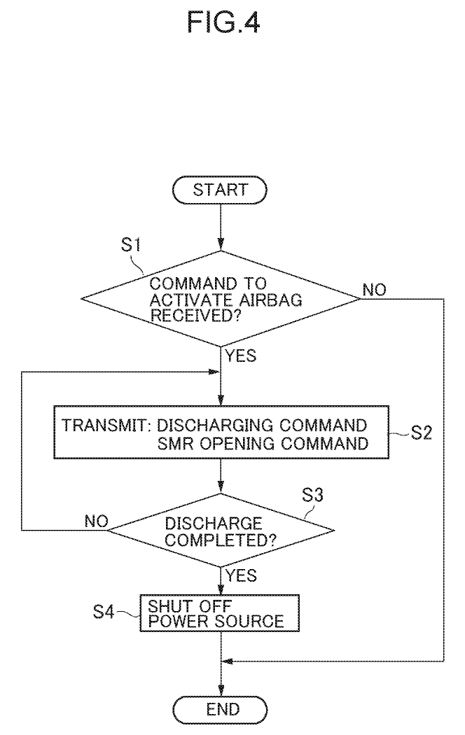

Turning to FIG. 4, there is shown one example of a routine for discharging the residual charges on the smoothing capacitors 10 and 16 in the event of a collision of the vehicle. At step S1, it is determined whether or not the collision signal receiver 43 receives the command signal for activating the airbag assembly. That is, it is determined at step S1 whether or not a collision of the vehicle occurs. Such determination at step S1 may be made based on a signal transmitted from the A/B-ECU 40 to the Main-ECU 37. Instead, it also may be determined at step S1 whether the acceleration detected by the acceleration sensor is equal to or greater than the predetermined value, or a time rate of change of the acceleration detected by the acceleration sensor is equal to or higher than the predetermined rate.

If the collision signal receiver 43 has not yet not received the command signal for activating the airbag assembly, that is, if the collision of the vehicle has not yet occurred so that the answer of the step S1 is NO, it is not necessary to discharge the residual charges from the smoothing capacitors 10 and 16. In this case, therefore, the routine returns. By contrast, if the collision signal receiver 43 receives the command signal for activating the airbag assembly so that the answer of the step S1 is YES, the routine progresses to step S2 to transmit a discharge command and an SMR opening command to discharge the residual charges from the smoothing capacitors 10 and 16. Specifically, at step S2, the Main-ECU 37 transmits the command signals to render the heater relays 35 and 36 conductive and the command signal to render the SMR 7 non-conductive.

Then, it is determined at step S3 whether or not the residual charges are discharged completely from the smoothing capacitors 10 and 16. For example, such determination at step S3 may be made based on a fact that a voltage of the first smoothing capacitor 10 detected by the first voltmeter 11 has decreased to a predetermined level or lower, and a fact that a voltage of the second smoothing capacitor 16 detected by the second voltmeter 17 has decreased to a predetermined level or lower.

If the residual charges have not yet been discharged completely from the smoothing capacitors 10 and 16 so that the answer of step S3 is NO, the determination at step S3 is repeated until the residual charges are discharged completely from the smoothing capacitors 10 and 16. By contrast, if the residual charges have been discharged completely from the smoothing capacitors 10 and 16 so that the answer of step S3 is YES, the routine progresses to step S4 to shut off the power source of the system, and thereafter returns.

As described above, the heater 32 is arranged in parallel with the motor 2, and the heater relays 35 and 36 for activating the heater 32 are adapted to electrically connect the smoothing capacitors 10 and 16 with the resistors 33 and 34. Therefore, the current is allowed to flow through each of the resistors 33 and 34 by rendering the heater relays 35 and 36 conductive thereby discharging the residual charges from the smoothing capacitors 10 and 16.

Thus, according to the exemplary embodiment of the present disclosure, the heater relays 35 and 36 are activated by supplying the electric power thereto from the Main-ECU 37. As mentioned above, if the power lines 41a and 41b connecting the auxiliary power source 39 and the MG-ECU 38, and the power lines for transmitting the gate signals from the MG-ECU 38 to the switching elements 20, 21, 22, 23, 24, and 25 are broken due to a collision of the vehicle, the PCU 4 may become out of control. Nonetheless, according to the exemplary embodiment of the present disclosure, the residual charges on the smoothing capacitors 10 and 16 may be discharged even in this situation by supplying the electric power from the Main-ECU 37 to the heater relays 35 and 36. In other words, the residual charges may be discharged from the smoothing capacitors 10 and 16 utilizing the existing ECU 37 without increasing the size of the system.

In the situation where the MG-ECU 38 functions properly to control the PCU 4, the residual charges on the smoothing capacitors 10 and 16 may be discharged according to the resistance values of the reactor 11a and 11b and the coils 2u, 2v, and 2w by controlling the switching elements 20, 21, 22, 23, 24, and 25 in such a manner as to adjust the torque of the motor 2 to zero while supplying the electric power to the motor 2. Whereas, in the situation where the PCU 4 is out of control, the residual charges on the smoothing capacitors 10 and 16 may also be discharged by activating the heater relays 35 and 36 by the Main-ECU 37 as an alternative means. That is, a method of discharging the residual charge on the smoothing capacitors 10 and 16 may be selected according to the degree or manner of the breakage caused by the collision of the vehicle. According to the exemplary embodiment of the present disclosure, therefore, the residual charge may be discharged certainly from the smoothing capacitors 10 and 16 in the event of the collision of the vehicle.

Although the above exemplary embodiment of the present disclosure has been described, it will be understood by those skilled in the art that the heating system according to the present disclosure should not be limited to the described exemplary embodiment, and various changes and modifications can be made within the scope of the present disclosure. For example, the resistor connected to the capacitor through the switch (or relay) activated by the Main-ECU should not limited to the above-mentioned heater, and an existing discharging resistor arranged in the vehicle may also be employed instead of the above-mentioned heater.

What is claimed is:

1. A control system for a vehicle, comprising:
a high-voltage power source;
a motor that is driven by electric power supplied from the high-voltage power source;
a power conversion equipment that converts the electric power supplied from the high-voltage power source and that outputs the converted electric power to the motor;
a capacitor that stores an electrical charge arranged between the high-voltage power source and the motor;
an auxiliary power source whose voltage is lower than that of the high-voltage power source;
a motor controller that controls the electric power supplied to the motor by supplying the electric power from the auxiliary power source to the power conversion equipment;
a main controller to which the electric power is supplied from the auxiliary power source, and that transmits a command signal to the motor controller in accordance with the electric power supplied to the motor;
a main relay that selectively interrupts a transmission of the electric power between the high-voltage power source and the capacitor;
a collision determiner that determines a collision of the vehicle;
a resistor having a resistance value equal to or greater than a predetermined value that is arranged in parallel with the motor; and
a discharging relay that selectively connects the capacitor with the resistor,
wherein the main controller comprises
an interrupter that controls the main relay to disconnect the high-voltage power source from the capacitor when the collision determiner determines the collision of the vehicle, and
a discharge controller that controls the discharging relay to connect the capacitor with the resistor when the collision determiner determines the collision of the vehicle.

2. The control system for the vehicle as claimed in claim 1, wherein the resistor includes a heater that heats water flowing in the vehicle.

3. The control system for the vehicle as claimed in claim 1, further comprising:
a first power line connecting the auxiliary power source with the motor controller; and
a second power line connecting the auxiliary power source with the main controller,
wherein the second power line is more difficult to be broken than the first power line in the event of the collision of the vehicle.

4. The control system for the vehicle as claimed in claim 1, wherein the power conversion equipment includes a converter having:
a switching element that allows current to flow from the motor to the high-voltage power source by supplying the electric power from the auxiliary power source to a gate, and
a diode that is arranged in parallel with the switching element such that the current is allowed to flow only from the high-voltage power source to the motor.
